(19) United States
(12) Patent Application Publication
(10) Pub. No.: US 2023/0088399 A1
(43) Pub. Date: Mar. 23, 2023

(54) ELECTROHYDRODYNAMIC DRYING OF MOIST POROUS MATERIALS

(71) Applicant: Worcester Polytechnic Institute Road, Worcester, MA (US)

(72) Inventors: Jamal S. Yagoobi, Hopkinton, MA (US); Mengqiao Yang, Worcester, MA (US)

(21) Appl. No.: 17/949,469

(22) Filed: Sep. 21, 2022

Related U.S. Application Data
(60) Provisional application No. 63/246,482, filed on Sep. 21, 2021.

(51) Int. Cl. F26B 23/04

(52) U.S. Cl. CPC F26B 23/04

(57) ABSTRACT

An electrohydrodynamic (EHD) drying apparatus includes a non-uniform electric field resulting from an electric field source operable for a high potential, and an electric field source operable for a low potential. A power source is connected to the electric field sources for producing the non uniform electric field for inducing dielectrophoresis (DEP) in an article within the uniform electric field. In particular configurations, the applied non-uniform electric field is for separating a vapor phase being formed during drying from the liquid phase. The electric field source defines a polarizer adapted to produce dielectrophoresis, and the electric field induces coupled electrostatics and momentum for disposing liquid towards the high electric field for drying.

### RELATED APPLICATIONS

This patent application claims the benefit under 35 U.S.C. § 119(e) of U.S. Provisional Patent App. No. 63/246,482, filed Sep. 21, 2021, entitled “ELECTROHYDRODYNAMIC DRYING OF MOIST POROUS MATERIALS,” incorporated herein by reference in entirety.

### BACKGROUND

Drying of moist porous media, such as paper and pulp, is an extremely energy-consuming process. Traditional drying techniques are primarily associated with convection, conduction, and thermal radiation. Other approaches include the use of cold, adsorptive and absorption surfaces for dehumidification. Efficient drying is often sought for moisture removal in industries such as food preparation.

### SUMMARY

An electrohydrodynamic (EHD) drying apparatus includes a non-uniform electric field resulting from an electric field source operable for a high potential, and an electric field source operable for a low potential. A power source is connected to the electric field sources for producing the non uniform electric field for inducing dielectrophoresis (DEP) in an article within the uniform electric field. In particular configurations, the applied non-uniform electric field is for separating a vapor phase being formed during drying from the liquid phase. The electric field source defines a polarizer adapted to produce dielectrophoresis, and the electric field induces coupled electrostatics and momentum for disposing liquid towards the high electric field for drying.

Configurations herein are based, in part, on the observation that many industrial processes rely on drying mechanisms for removing moisture from goods, products and other industrial entities. Often this includes water absorbed or contained in food and other porous products, however any evaporative process may be applicable to approaches herein. Unfortunately, conventional approaches to drying are energy intensive and involve electrical and/or fossil fuel consumption for generating heat and airflow for commercial drying. Accordingly, configurations herein substantially overcome the shortcomings of conventional approaches by employing a Dielectrophoresis (DEP, or dielectrophoretic) mechanism to generate a non-uniform electric field and promoting a DEP force that assists drying by a gradient of electrical that differs for the liquid and vapor phases of the moisture content. During the drying process, in the presence of the DEP force, the vapor phase is extracted away from the porous drying medium, which results in an increase of the evaporation rate.

In further detail, an electrohydrodynamic drying apparatus according to configurations herein includes an emitter connected to a power source for providing a voltage, and a collector connected to the power source and having a lower voltage that the emitter for establishing a non-uniform electric field between the emitter and collector. An induced dielectrophoretic field results between the emitter and collector is configured for selectively disposing the moisture content out of the article for drying.

A method for EHD drying using the drying apparatus includes establishing a voltage differential between an EHD electrode plate and a ground electrode plate, where the EHD electrode plate is connected to a power source for providing a voltage, and the ground electrode plate is connected to the power source and has a lower voltage that the emitter. Drying logic energizes the power supply for establishing a non-uniform electric field between the EHD electrode plate and the ground electrode plate, and an article for drying is placed between the EHD electrode plate and the ground plate based on a dielectrophoretic field induced by the power source between the EHD electrode plate and the ground electrode plate for removing the moisture content from the article.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context level diagram of a drying environment 100 suitable for use with configurations herein;

FIG. 2 shows a schematic diagram of dielectrophoresis as a translational motion of neutral matter caused by polarization effects in a non-uniform electric field;

FIG. 3 is a schematic diagram of a drying apparatus using the forces of FIG. 2 for DEP enhancement of moisture removal (evaporation) from an article;

FIG. 4 shows a system for applying the draying apparatus of FIG. 3 to an industrial process;

FIG. 5 is a diagram of a DEP electrode, or emitter, in the approach of FIGS. 1-4;

FIG. 6 is a diagram of a ground electrode, or collector, in the approach of FIGS. 1-4;

FIG. 7 is a graph of a comparison of heat flux as a function of drying time under various applied potentials;

FIG. 8 is a comparison of local temperature evolution of drying under various applied potentials;

FIG. 9 shows voltage and current as a function of drying time with applied potential of 4 kV;

FIG. 10 is a comparison of DBMC under various applied potentials as a function of time;

FIG. 11 is comparison of heat transfer coefficients under various applied potentials as a function of time; and

FIG. 12 is a comparison of drying rate under various applied potentials as a function of time.

### DETAILED DESCRIPTION

The description below presents an example of the DEP drying apparatus applicable for drying a substrate or product using an article of a moist porous medium within the DEP field for drawing water or other evaporated substance away from the moist, porous article (article) for drying the article.

DEP, as applied to configurations herein, provides a translational motion of neutral matter caused by the polarization effects in a diverging electric field. During the drying process, in the presence of the DEP force, the vapor phase is extracted away from the porous medium, which results in an increase of the evaporation rate and a decrease of the sample surface temperature. DEP also enhances heat-transfer characteristics, demonstrated by monitoring a heat flux rate during the drying process. The article temperature is monitored through an Infrared (IR) camera, and convection heat transfer coefficients are estimated for evaluating moisture content is studied as a function of drying time. The experimental results show an up to 132% increase of the heat flux rate and a 242% increase of the convection coefficient due to the application of an electric field, as compared to conventional drying process.

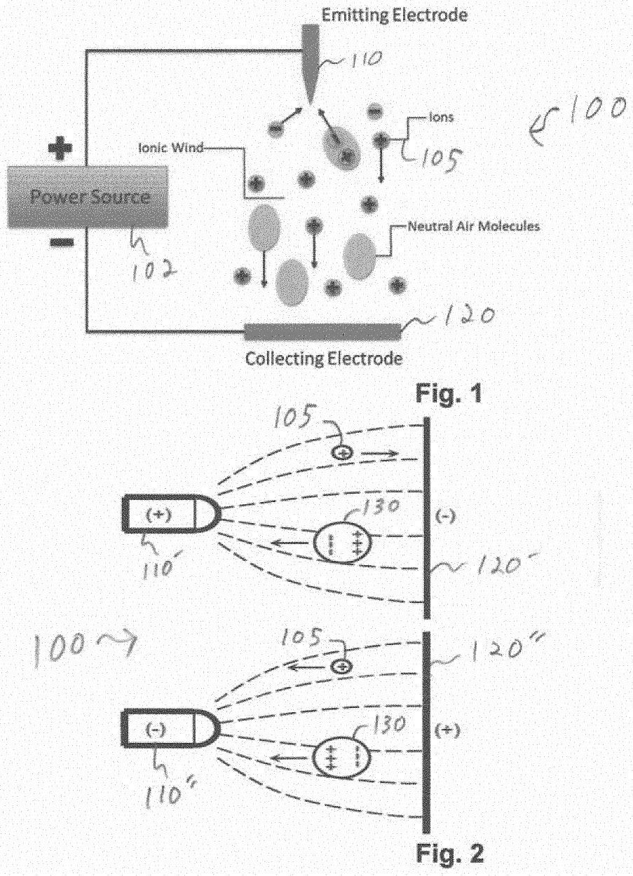

FIG. 1 is a context level diagram of a drying environment 100 suitable for use with configurations herein. An emitting electrode 110 carries a higher voltage than a collecting electrode 120, typically at ground, driven by a power source 102. Electrohydrodynamic (EHD) drying defines a promising drying technique based on an EHD phenomenon resulting from an interaction between fluid flow fields and electric fields. In general, EHD encompasses three electrical body forces:

$${f}_{e} = {ρ}_{e} E - \frac{1}{2} {E}^{2} ∇ {ε}_{e} + \frac{1}{2} ∇ [ {{E}^{2} ( \frac{\partial {ε}_{e}}{\partial ρ} )}_{T} ρ ]$$

Where ρe, E, εe, and ρ are the electric charge density, the electric field vector, the electric permittivity, and mass density of the fluid medium, respectively, and promote ion 105 flow towards the collecting electrode (collector) 120. The first term on the right hand side represents the Coulomb force. The Coulomb force can attract or repel objects due to the existence of free ions. Three mechanisms are responsible for the ion source: injection or ion-drag, conduction, and induction. The second force (middle term) is the Dielectrophoretic (DEP) force, which is due to the existence of an electric permittivity gradient in a multiphase system. The third force, the electrostriction force, is due to the elastic deformation of a fluid medium by an imposed electric field and can be neglected for incompressible fluids. The nomenclature of Table I is employed throughout:

TABLE I

| | | |
|---|---|---|
| A | Surface area | m² |
| c | Specific heat | J/kg · K |
| D | Mass diffusivity | m/s² |
| E | Electric field vector | V/m |
| fₑ | Electric body force | N/m³ |
| | density | |
| h | Heat transfer | W/m² · K |
| | coefficient | |
| h_{fg} | Latent heat of | kJ/kg |
| | evaporation | |
| I | Electric current | mA |
| J | Mass flux | kg/m² · s |
| k | Thermal conductivity | W/m · K |
| kₘ | Mass transfer | kg/m² · s |
| | coefficient | |
| m₁ | Instantaneous weight | g |
| | of sample without DEP | |
| | electrode energized | |
| m₂ | Instantaneous weight | g |
| | of sample with DEP | |
| | electrode energized | |
| p | Perforation gap size of | mm |
| | DEP electrode | |
| P | Pressure | KPa |
| q″ | Heat flux rate | W/m² |
| r | Radius of hand-sheet | m |
| | paper | |
| t | time | s |
| εₑ | Electric permittivity | F/m |
| ρₑ | Space charge density | C/m³ |
| ρ | Fluid density | kg/m³ |
| ν | Kinematic viscosity | m²/s |

Conventional EHD based drying techniques make use of ionic/corona wind generation, whose primary mechanism is the Coulomb force. In general, ionic wind generation requires an emitting electrode with a small radius of curvature (e.g., needle-shaped) and a collecting/ground electrode, which can be problematic in industrial usage due to the needle shaped electrode tending to oxidize. Conventional EHD approaches may tend to manipulate the Coulomb force, in contrast to configurations herein which drive evaporation based on the DEP force.

FIG. 2 shows a schematic diagram of dielectrophoresis as a translational motion of neutral matter caused by polarization effects in a non-uniform electric field. As an alternative to the ionic wind forces shown in FIG. 1, the Dielectrophoresis (DEP) mechanism, represented as the second term above, provides an energy efficient avenue for enhancing the drying process. DEP is a translational motion of neutral matter caused by polarization effects in a non-uniform electric field. As illustrated in the equation above, the existence of the DEP force depends on the gradient of electric permittivity and electrical field strength. Electric permittivity is a material-dependent property; for instance, the electric permittivity of liquid water and water vapor are ε1=7.08×10⁻¹⁰ F/m (20° C.) and ε2=8.854×10⁻¹² F/m, respectively. Thus, the permittivity gradient vanishes in a single-phase system, due to the identical property in the medium. In a typical two-phase (liquid and vapor) system, the DEP force plays a role in phase separation. The strength magnitude, and the direction of the DEP force depends on the dielectric properties. In other words, the vapor phase, with low electric permittivity, moves towards the low electric field end, while the liquid phase, with high electric permittivity, moves toward the other end. Note that the DEP force generation is independent of the electric potential polarity, which makes it feasible for both DC and

AC applications.

Referring to FIGS. 1 and 2, in the drying environment 100 of FIG. 2, an electrohydrodynamic (EHD) drying mechanism includes an emitter 110′, 110″ (110 generally) connected to a power source for providing a voltage. A respective collector 120′, 120″ (120 generally) connected to the opposed pole of the power source has a different voltage that the emitter 110 for establishing a non-uniform electric field between the emitter 110 and collector 120. A dielectrophoretic field 150 is induced by the power source between the emitter 110 and collector 120 configured for selectively disposing the moisture content out of an article 325 for drying. A vapor bubble 130 with low permittivity will move toward low electric field defined by the emitter 110. Liquid with high permittivity will move toward high electric field defined by the collector 120. DEP forces therefore move the vapor bubbles 130 for drying regardless of the polarity, depending on the high and low electric fields, independent of polarity of the applied potential from the voltage source 102.

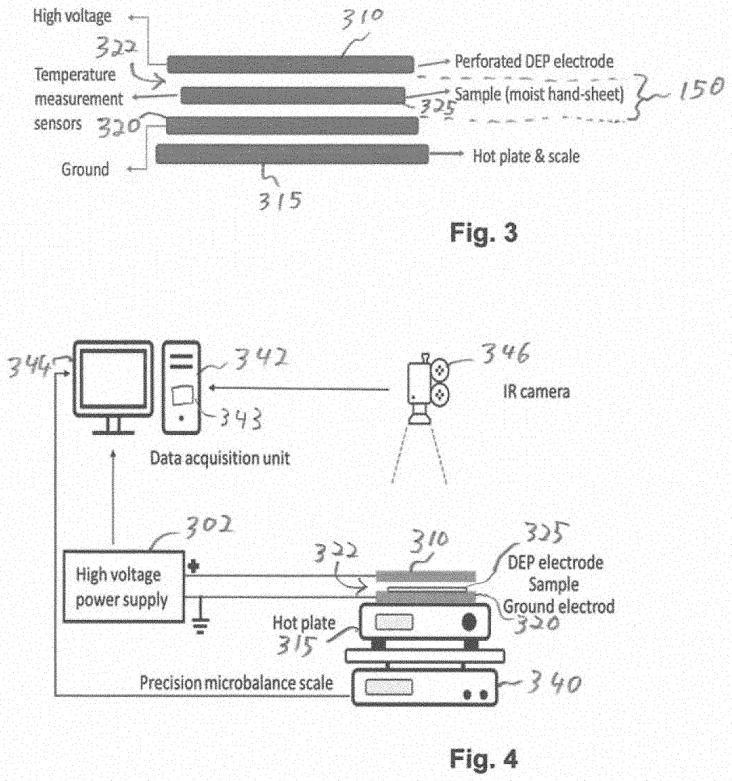

FIG. 3 is a schematic diagram of a drying apparatus using the forces of FIG. 2 for DEP enhancement of moisture removal (evaporation) from an article 325. The example article 325 is a moist, porous medium and the dielectrophoretic field imparts movement to liquid phases and vapor phases of the moisture based on an electrical permittivity of the moisture. In configurations herein, the moisture includes water such that the electrical permittivity in the vapor phase is lower than the electrical permittivity of the liquid phase. Accordingly, the vapor phase is drawn towards the emitter 110 based on a lower electric field at the emitter.

FIG. 3 depicts an apparatus suitable for evaluating the heat transfer characteristic during the drying of the article. In operation, the article may be food products in need of drying, wood or paper based products, or other suitable medium for which drying is employed for extracting water or other liquid through evaporation and DEP movement. In the configuration of FIG. 3, the emitter 110 is a DEP electrode 310 directly installed above the collector 120, implemented as a ground electrode 320. In the example configuration, the article 325 is a hand sheet paper prepared with hardwood pulp at an initial dry basis moisture content of 680%±5% and diameter of 159 mm. An air gap 322 of 6.1 mm was maintained between the article 325 and the DEP electrode 310. The DEP electrode 310, article 325, as well as the ground electrode 320 were installed on a heat source 315 defined by a temperature controlled hot plate surface. The hot plate was used to supply continuous heating underneath the ground electrode at a fixed temperature; in the disclosed approach, 100° C. was set for the hot plate temperature. The DEP electrode 310 was powered by a high-voltage power supply grounded by the ground electrode 320.

The heat source 315 is disposed adjacent the article 325, such that the heat source heats the article for evaporating the moisture to generate the vapor phase, such that the dielectrophoretic field 150 disposes the vapor phase in a direction based on an electric permittivity of the moisture for removing the liquid phase from the article 325. Based on water vapor evaporated from the article 325 via heating from the heat source 315, the gaseous vapor phase is drawn towards the DEP electrode across the air gap 322, thus enhancing the drying process and reducing the amount of energy needed for the heat source 315.

FIG. 4 shows a system for applying the draying apparatus of FIG. 3 to an industrial process. In the approach of FIGS. 2-4, the article 325 is disposed in the non-uniform electric field (DEP field 150) between the emitter and the collector. The power source generates a lower electric field at the DEP electrode for inducing a vapor pressure gradient at the article to drive the vapor phase towards the emitter. The DEP (dielectrophoretic) electrode 310 opposes the ground electrode 320 for defining the non-uniform electric field 150, where the article 325 is disposed between the DEP electrode and the ground electrode. The air gap 322 is a separation between the DEP electrode and the article, such that the induced electric field is higher at the article than at the DEP electrode for separating liquid and vapor phases of the moisture, causing the vapor phase to incur forces towards the DEP electrode based on the DEP force.

An Infrared (IR) camera 346 installed 1 m above the DEP electrode 310 was used to monitor the surface temperature evolution during the drying process. The temperature data is gathered and rendered by a data acquisition unit including a processor 342 and rendering screen 344. The heat flux measurement was achieved by a miniature heat flux sensor installed at the ground electrode 320, discussed further below in FIG. 6. The processor 342 accesses drying logic 343 for energizing the DEP electrode 310 according to voltage levels and polarity predetermined by the drying logic 343. The heat source 340 may be a fixed, separately controlled temperature or may be directed by the drying logic 343.

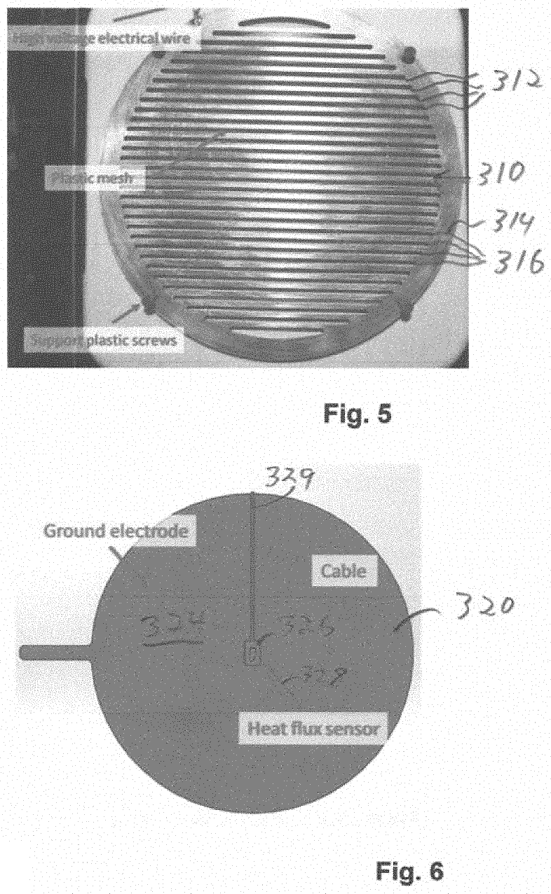

FIG. 5 is a diagram of a DEP electrode, or emitter, in the approach of FIGS. 1-4. The DEP electrode 310 is a conductive material with a plurality of parallel elongated members 312 and a surrounding border 314 of the conductive material attached to each of the parallel elongated members. A slot 316 forms between each of the parallel elongated members 312 and adjacent parallel elongated members to form a grate-like structure. In the example configuration, a stainless-steel construction of the DEP electrode 310 was utilized.

The dimensions of the electrodes and paper sample are shown in Table II. The electrode sizes were fabricated in consideration of the size of the hand-sheet paper article. The DEP electrode design was based on a design used for the enhancement of heat transfer in electrically driven, liquid film flow in the absence of gravity. A numerical simulation was carried out to estimate the electric field distribution generated by this electrode design. The numerical simulation results indicated that, for the main region of the domain, the electric field 150 is highest in the vicinity of the article and decreases along the area through the plurality of the DEP electrode slots 316. As a result, as evaporation proceeds, vapor departs the sample surface, and the DEP force extracts the vapor phase towards the lower electric field. In other words, the vapor phase moves from the sample surface to the slots in the DEP electrode under the influence of the DEP force. This DEP extraction mechanism will increase the vapor pressure gradient between the sample surface and its surrounding ambient, thus, enhancing evaporation/dry rate in the vicinity of the article 325.

As further demonstrated in FIGS. 3-5, the elongated members 312 and slots 316 meet a surrounding border 314 that has a circular shape such that the parallel, elongated members 312 meet the surrounding border 314 at a point based on an equidistance spacing defined by a width of the slots. The circumferential shape of the surrounding border 314 may take other forms in alternate configurations. Example dimensions of the DEP electrode 310 are shown in Table II, and may be adjusted as needed to enhance the DEP force.

TABLE II

| | Dimensions |
|---|---|
| Characteristic length | (mm) |
| Outer diameter of the DEP electrode | 222 |
| Inner diameter of the DEP elec trode | 197 |
| Perforation gap size (p) of the DEP | 3 |
| electrode | |
| Thickness of the DEP electrode | 1.55 |
| Diameter of the ground electrode | 171 |
| Thickness of the ground electrode | 1.22 |
| Distance between the DEP electrode | 6.5 |
| and ground electrode (a) | |
| Thickness of the hand-sheet paper (b) | 0.4 |

FIG. 6 is a diagram of the ground electrode, or collector, in the approach of FIGS. 1-4. Referring to FIGS. 1-6, in the example herein, the collector 120 defines a ground electrode 320 including a conductive surface 324, and a centrally disposed slot 326 for sensing heat flux through the article. The slot 326 is adapted to receive a heat flux sensor 328 for measuring heat flux and determining the heat applied to the article 325 for assessing moisture removal and drying completeness. A signal cable 329 connects the heat flux sensor 328 to the processor 342 for monitoring and control.

In order to measure the incoming heat flux rate (q″) that penetrates the article 325 from below, a miniature heat flux sensor was employed (micro-foil heat flux sensor, RDF corporation). The heat flux sensor has a dimension of 12 mm (L)×7 mm (W)×1 mm thickness. To accommodate the sensor measurements into the existing dry experiments without introducing geometrical influence, the ground electrode was redesigned by inserting the rectangle-shaped slot 326 in the center. The heat flux sensor 328 was sealed into the slot with thermal conductive epoxy. The excess epoxy was removed and polished using 600-grit sandpaper, in order to keep the surface of the region as smooth as possible. The heat flux sensor is connected to the processor 342. The output voltage in the micro-voltage range is then converted to the heat flux rate, by multiplying the scaling factors provided by the sensor manufacturer. Note that the heat flux rate presented in this work is based on the local measurement; accordingly, the temperature above the heat flux sensor region measured by an IR camera 346.

The moisture content is based on the dry basis weight (DBMC), which is the ratio between the mass weight of water over the bone-dry weight of the dry article 325, as:

$$DBMC = \frac{instantaneous mass of water ( g )}{bone dried mass of sample ( g )} \times 100 \%$$

The drying rate is defined as the change in the mass per unit area of the article 325 and per unit time. The derivation here is a second order centered difference approximation:

$$DR = \frac{Bone dried weight ( g )}{A ( {m}^{2} )} \times \frac{D B M {C}_{t + dt} - D B M {C}_{t - dt}}{2 dt}$$

Where A represents the surface area of the article 325.

In the convective heat transfer coefficient analysis, the total heat flux from the heat source 315 to the article 325 includes two parts: latent heat of vaporization and sensible heat. Thus, estimating the heat transfer coefficient becomes a challenge without knowing the ratio of the two parts. However, as mentioned above, the drying rate, or, more specifically, the evaporation rate, could be obtained. Thus, the local convective heat transfer coefficient estimation is achievable per the following equations. In this approach, the mass transfer coefficient, km, is linked with the vapor mass flux (Jv), due to surface evaporation and the convection heat transfer coefficient (hconv):

$${J}_{v , o} = {k}_{m} \times ( \frac{{P}_{v} - {P}_{v , a}}{{P}_{atm}} )$$

$${k}_{m} = \frac{{h}_{conv}}{{c}_{a}} \times {( \frac{{c}_{a} {ρ}_{a} {v}_{a}}{{k}_{a}} )}^{\frac{2}{3}} ( \frac{{v}_{a}}{{D}_{v}} )$$

It should be noted that various semi-empirical correlations are used for estimating the physical properties of the sample.

Upon the penetration of heat to the article 325 from the bottom heat source 315, phase change (i.e., evaporation) occurs. In this manner, the total heat includes both sensible heating of the moist medium (more precisely, the article and the trapped moisture therein) and the latent heat of vaporization. Thus, the heat flux and surface temperature evolutions, as well as the voltage/current characteristics, are shown simultaneously, to investigate the influence of the DEP force on drying performance.

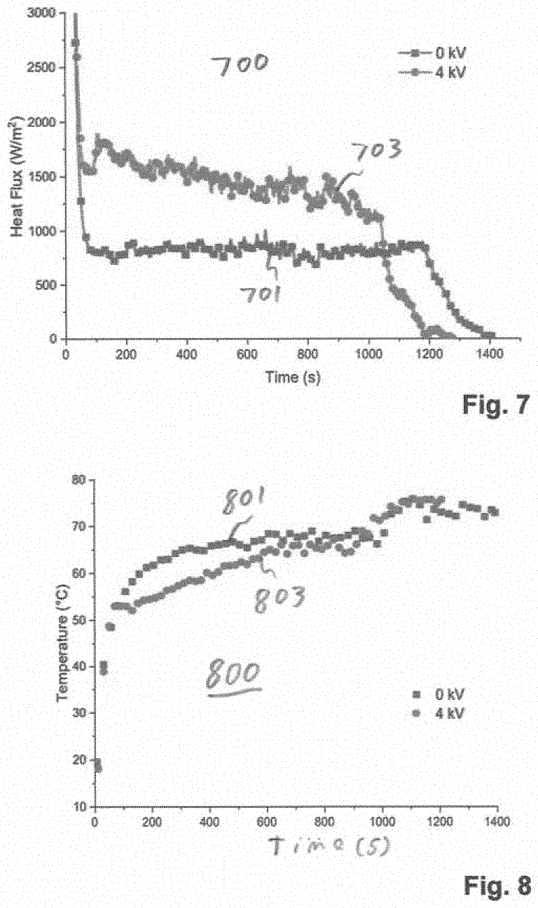

FIG. 7 is a graph of a comparison of heat flux as a function of drying time under various applied potentials. In FIG. 7, the comparison 700 of heat flux rate under 0 V 701 and 4 kV 703 is shown with a single-layer, hand-sheet paper sample used as the article 325. When a relatively cold paper sheet (18° C.) sample is placed on the hot plate surface, the appearance of an immediate large temperature gradient causes the heat flux to experience a sudden jump to a maximum value of more than 9000 W/m².

FIG. 8 is a comparison 800 of local temperature evolution of drying under 0 V 801 and 4 kV 803. Referring to both FIGS. 7 and 8, for t<100 s, as the heat dissipates from the hot plate to the paper sample, the sample temperature increases because of sensible heating, which results in a gradual decrease of the heat flux rate, as illustrated, before t=100 s, in FIGS. 7 and 8. Then, the heat flux, and the local temperature remain at relatively constant rates, due to the existence of evaporation. Later, at t=1200 s, the heat flux starts to drop because the sample is almost fully dried, see in FIG. 10 below. The surface temperature increased due to the second sensible heating period (i.e., no evaporation). Note that, due to the thermal conductivity differences between the epoxy and stainless steel, at low moisture content levels, paper bulging effects occur, which introduce an insulation gap layer between the upper surface of the flux sensor and the bottom surface of the paper sample. Thus, the sample temperature generally did not attain the same temperature as the heat source 315 surface.

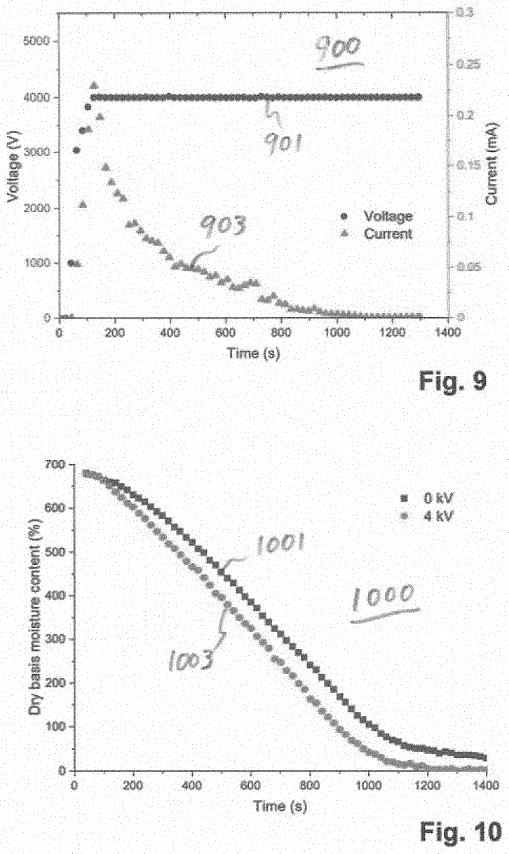

FIG. 9 shows voltage and current as a function 900 of drying time with applied potential of 4 kV, and includes the voltage 901 and current 903 characteristic under an applied voltage of 4 kV. As the DEP electrode 310 was energizing, initially, surface temperature increased, and heat flux decreased, as depicted in FIGS. 7 and 8. This is identical with those under a regular drying process. However, as the applied potential increased (e.g., at t=65 s, when voltage reached 3 kV), the surface temperature started to decrease, which resulted in an increase of heat flux. This indicated that an increased amount of heat penetrated the paper sample from the hot plate, due to the application of the electric field. At t=130 s, the heat flux reached the local maximum value, when the applied voltages reached the target value. At this moment, the heat flux of the sample surface exposed to the DEP electrode energized of 4 kV was greater than that of 0 kV by 132% (1845 W/m² versus 795 W/m², respectively). Meanwhile, note that the surface temperature of the paper sheet exposed to the electric field increased at a lower rate, as compared to the temperature under the regular drying process. As an example, at t=130 s, the surface temperature of the sample surface exposed to the DEP electrode energized of 4 kV was lower than that of 0 kV by 6° C. (52° C. versus 58° C., respectively). This is due to the enhancement of evaporation by the DEP force since evaporation is an endothermic process. According to FIG. 7, at the period of t=1000 s, the heat flux under the DEP drying decreased prior to that of regular drying (i.e., 0 kV). This is because the sample reached the second sensible heating period earlier with the application of DEP mechanism. Taken together, compared to the regular drying process without applied voltage (i.e., 0 kV), the DEP enhanced drying process shows a significant reduction of surface temperature and enhancement of high flux that penetrates the sample, which, in turn, improves the overall drying rate.

FIG. 10 is a comparison of DBMC (Dry Basis Moisture Component) under various applied potentials (0 V 1001; 4 kV 1003) as a function of time. The DEP mechanism indicated a significant improvement of the drying rate in comparison with the regular drying process (i.e., 0 kV) without applied voltage. Accordingly, the comparison 1100 of drying rate is below in FIG. 12 for 0 V 1201 and 4 kV 1203. The DEP enhanced drying process showed a substantially higher drying rate compared to that of regular drying process. As an example, at t=200 s, the drying rates for 0V case and 4 kV cases were 0.5 and 0.8 g/m² s, respectively. In addition, the drying rate of the 4 kV case decreased prior to that of the 0 kV case, for example, at t=800 s, because the sample is almost fully dried with exposure to the electric field, as explained above.

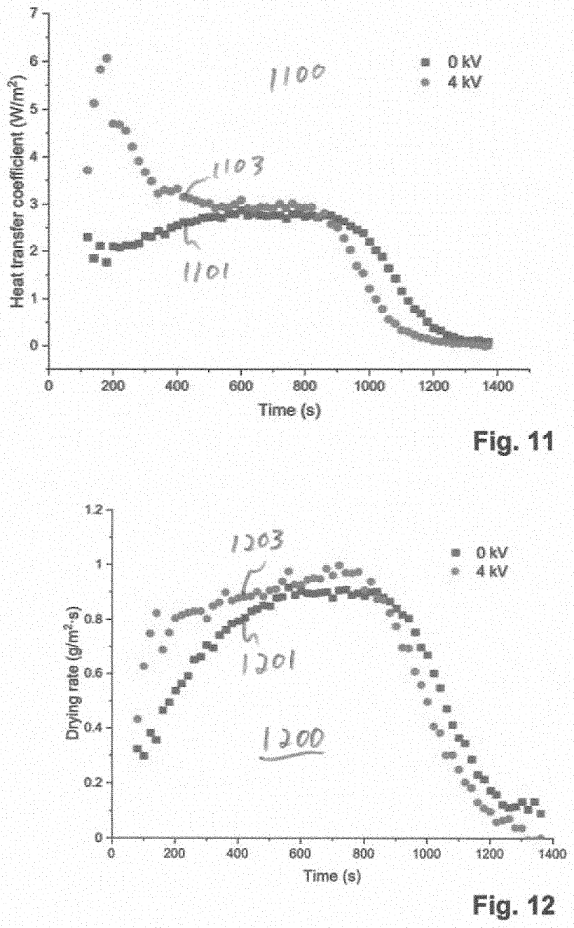

The corresponding convective heat transfer coefficients 1100 are presented in FIG. 11. The DEP mechanism showed a higher heat transfer coefficient compared to that of regular drying process. For instance, at t=180 s, the local heat transfer coefficients for 0 kV 1101 and 4 kV 1103 cases were 1.77 and 6.06 W/m², respectively, which illustrated an enhancement of 242% in heat transfer coefficients with the application of the electric field. Additionally, it is noticeable that the heat transfer enhancement primarily occurred before a certain time instant (e.g., at t=800 s, the DBMC of paper is 150% in 4 kV case), where the sample moisture content is relatively high. The influence of lower initial moisture content will be investigated in the following section. The order of magnitude of the estimated heat transfer coefficient by the DEP mechanism indicates its significant influence in the natural convection process. Thus, this novel mechanism could be extremely beneficial for drying fragile materials, where forced convection is not desirable.

Configurations discussed above demonstrate the heat transfer characteristics of drying an article 325 defined by a moist paper sheet heated from bottom with the DEP mechanism showed a significant enhancement in heat flux and the convective heat transfer coefficient up to 132% and 242%, respectively, when the paper sheet was exposed to the electric field. However, the DEP effects are particularly quantifiable with a higher initial moisture content. The disclosed approach confirms efficacy of a novel mechanism for an intensification of the drying process and provided additional physical insights of the disclosed approach for drying fragile products.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a drying environment including an article having moisture content, an electrohydrodynamic (EHD) drying apparatus, comprising:
an emitter connected to a power source for providing a voltage;
a collector connected to the power source and having a lower voltage that the emitter for establishing a non-uniform electric field between the emitter and collector; and
a dielectrophoretic field induced by the power source between the emitter and collector configured for selectively disposing the moisture content out of the article.

2. The apparatus of claim 1 wherein the article is a moist, porous medium and the dielectrophoretic field imparts movement to liquid phases and vapor phases of the moisture based on an electrical permittivity of the moisture.

3. The apparatus of claim 1 wherein the moisture includes water and the electrical permittivity in the vapor phase is lower than the electrical permittivity of the liquid phase, the vapor phase being drawn towards the emitter based on a lower electric field at the emitter.

4. The apparatus of claim 2 wherein the article is disposed in the non-uniform electric field between the emitter and the collector and the power source generates a lower electric field at the emitter for inducing a vapor pressure gradient at the article to drive the vapor phase towards the emitter.

5. The apparatus of claim 1 wherein a DEP (dielectrophoretic) electrode opposes a ground electrode for defining the non-uniform electric field, the article disposed between the DEP electrode and the ground electrode,
further comprising an air gap between the article and the DEP electrode, the induced electric field higher at the article than at the DEP electrode for separating liquid and vapor phases of the moisture, the vapor phase incurring forces towards the DEP electrode based on the DEP force.

6. The apparatus of claim 1 further comprising a heat source disposed adjacent the article, the heat source heating the article for evaporating the moisture to generate the vapor phase, the dielectrophoretic field disposing the vapor phase in a direction based on an electric permittivity of the moisture for removing the liquid phase from the article.

7. The apparatus of claim 5 wherein the DEP electrode is a conductive material, further comprising:
a plurality of parallel elongated members;
a surrounding border of the conductive material attached to each of the parallel elongated members; and
a slot between each of the parallel elongated members and an adjacent parallel elongated members.

8. The apparatus of claim 7 wherein the surrounding border has a circular shape and the parallel, elongated members meet the surrounding border at a point based on an equidistance spacing defined by a width of the slots.

9. The apparatus of claim 6 wherein the collector defines a ground electrode including a conductive surface, and
a centrally disposed slot for sensing heat flux through the article.

10. A method for electrohydrodynamic (EHD) drying, comprising:
establishing a voltage differential between an EHD electrode plate and a ground electrode plate;
the EHD electrode plate connected to a power source for providing a voltage;
the ground electrode plate connected to the power source and having a lower voltage that the emitter;
energizing the power supply for establishing a non-uniform electric field between the EHD electrode plate and the ground electrode plate;
disposing an article for drying between the EHD electrode plate and the ground plate based on a dielectrophoretic field induced by the power source between the EHD electrode plate and the ground electrode plate for removing the moisture content out of the article.

11. The method of claim 10 further comprising separating a vapor phase being formed during drying from a liquid phase of the moisture in the article.

12. An electrohydrodynamic (EHD) drying apparatus, comprising:
a non-uniform electric field resulting from:
an electric field source operable for a high potential;
an electric field source operable for a low potential;
a power source connected to the electric field sources for producing the non uniform electric field for inducing dielectrophoresis (DEP) in an article within the uniform electric field.

13. The device of claim 12 wherein the applied non-uniform electric field is for separating a vapor phase being formed during drying from the liquid phase.
